(19) United States
(12) Patent Application Publication
(10) Pub. No.: US 2010/0235782 A1
(43) Pub. Date: Sep. 16, 2010

(54) Systems and Methods For Viewing Patient Data

(75) Inventors: William Cameron Powell, San Antonio, TX (US); Stephen Trey Moore, San Antonio, TX (US)

Correspondence Address: FISH & RICHARDSON P.C., P.O BOX 1022, Minneapolis, MN, 55440-1022, US

(73) Assignee: AIRSTRIP DEVELOPMENT, L.P., San Antonio, TX (US)

(21) Appl. No.: 12/722,341

(22) Filed: Mar. 11, 2010

Related U.S. Application Data
(60) Provisional application No. 61/159,138, filed on Mar. 11, 2009.

(51) Int. Cl. G06F 3/048; G06Q 10/00; G06Q 50/00; G06F 15/16; G06F 17/30

(52) U.S. Cl. 715/809; 705/2; 709/219; 715/764; 707/827; 707/E17.01

(57) ABSTRACT

Implementations of the present invention include methods of providing and managing patient data. In some implementations, methods include providing patient data to a data management system that is in communication with an information system located at a facility, providing the patient data to a remote device that is in communication with the data management system, receiving, in the remote device, ancillary information that is input based on the patient data, providing the ancillary information to the data management system, and providing the ancillary information to the information system from the data management system.

### CROSS-REFERENCE TO RELATED APPLICATIONS

This application claims priority to U.S. Provisional Application No. 61/159,138, filed on Mar. 11, 2009, the disclosure of which is expressly incorporated herein by reference in its entirety.

### FIELD

This invention generally relates to systems and methods for transmitting, receiving and displaying data and/or information over wireless communication and data processing devices, and more specifically to a system and method for collecting, uploading, transmitting, receiving, downloading, manipulating, and displaying medical patient data and/or information to a remote device operable by a health care provider.

### BACKGROUND

While physicians and other health care providers currently utilize a large number of products and systems that benefit from advances in wireless communication technology, there are still significant limitations to the information that can be transmitted, received, and displayed over these devices in a practical and efficient manner. There are many limitations that are intrinsic to mobile devices, especially those constraints related to speed, performance, memory, and display size. In addition, because of the critical nature of medical data, it is important that the technology work reliably and efficiently over potentially low speed, low bandwidth, and sometimes intermittent wireless connections.

Efforts have been made in the past to transmit medical information through various telecommunication means to health care professionals for review and analysis.

Some such efforts are outlined in commonly assigned U.S. patent application Ser. No. 11/301,348, filed on Dec. 12, 2005, the disclosure of which is expressly incorporated herein by reference in its entirety for all purposes. Such examples utilize wireless data communication technologies to transmit medical information to health care providers, or to condition data such that it may be useful for remote monitoring purposes.

### SUMMARY

In one aspect, the present invention provides a method of providing and managing patient data. In some aspects, the method includes providing patient data to a data management system that is in communication with an information system located at a facility, providing the patient data to a remote device that is in communication with the data management system, receiving, in the remote device, ancillary information that is input based on the patient data, providing the ancillary information to the data management system, and providing the ancillary information to the information system from the data management system.

In some aspects, the method further includes providing an interface that is associated with the information system, and displaying the ancillary information on the interface.

In some aspects, the method further includes displaying patient data on the remote device, and associating the ancillary information with particular patient data that is displayed on the remote device.

In some aspects, the method further includes displaying an annotation on the remote device, which annotation having been generated at the facility.

In some aspects, the annotation is generated based on user input into the information system. In some aspects, the annotation is automatically generated by a patient monitoring device that is in communication with the information system.

In some aspects, the method further includes generating a dialog box on a display of the remote device, and inputting the ancillary information into the remote device using the dialog box.

In some aspects, the ancillary information includes at least one of an annotation, a digital image, digital video, audio and an electronic document.

In some aspects, the method further includes processing and formatting the ancillary information using the data management system for subsequent display at the facility.

In other aspects, the invention also provides computer-readable medium encoded with a computer program comprising instructions that, when executed, operate to cause one or more processors to perform one or more of the methods provided herein.

Other aspects of the invention provide system including one or more processors, and a computer-readable medium coupled to the one or more processors having instructions stored thereon which, when executed by the one or more processors, cause the one or more processors to perform one or more of the methods provided herein.

It is appreciated that methods in accordance with the present disclosure can include any combination of the aspects and features described herein. That is to say that methods in accordance with the present disclosure are not limited to the combinations of aspects and features specifically described herein, but also include any combination of the aspects and features provided.

The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic illustration of an exemplar system architecture in accordance with the present disclosure.

FIG. 2 is a schematic illustration of another exemplar system architecture in accordance with the present disclosure.

FIG. 3 is a functional block diagram of components that can be used to implement the present disclosure.

FIG. 4 is a more detailed view of the functional block diagram of FIG. 3.

FIGS. 5A-5K provide exemplar screenshots on an exemplar mobile device in accordance with the present disclosure.

FIG. 6 is a functional block diagram illustrating a user authentication routine in accordance with implementations of the present disclosure.

FIG. 7 is a flowchart illustrating exemplar steps in accordance with some implementations of the present disclosure.

FIG. 8 is a flowchart illustrating exemplar steps in accordance with some implementations of the present disclosure.

FIG. 9 is a flowchart illustrating exemplar steps in accordance with some implementations of the present disclosure.

FIG. 10 is a flowchart illustrating exemplar steps in accordance with some implementations of the present disclosure.

Like reference symbols in the various drawings indicate like elements.

### DETAILED DESCRIPTION

The present disclosure provides a healthcare provider with secure, remote access to patient data. The present disclosure builds on that of commonly assigned U.S. patent application Ser. No. 11/301,348, filed on Dec. 12, 2005, the disclosure of which is expressly incorporated herein by reference in its entirety for all purposes. U.S. patent application Ser. No. 11/301,348 claims the benefit of U.S. Prov. App. No. 60/641,057, filed on Jan. 3, 2005, the disclosure of which is also expressly incorporated herein by reference in its entirety for all purposes. For purposes of the instant description, and by way of non-limiting example, implementations of the present disclosure will be described in the context of patient data corresponding to maternity patients (e.g., obstetric (OB) patient). Implementations of the present disclosure are applicable to any variety of patients and corresponding patient data.

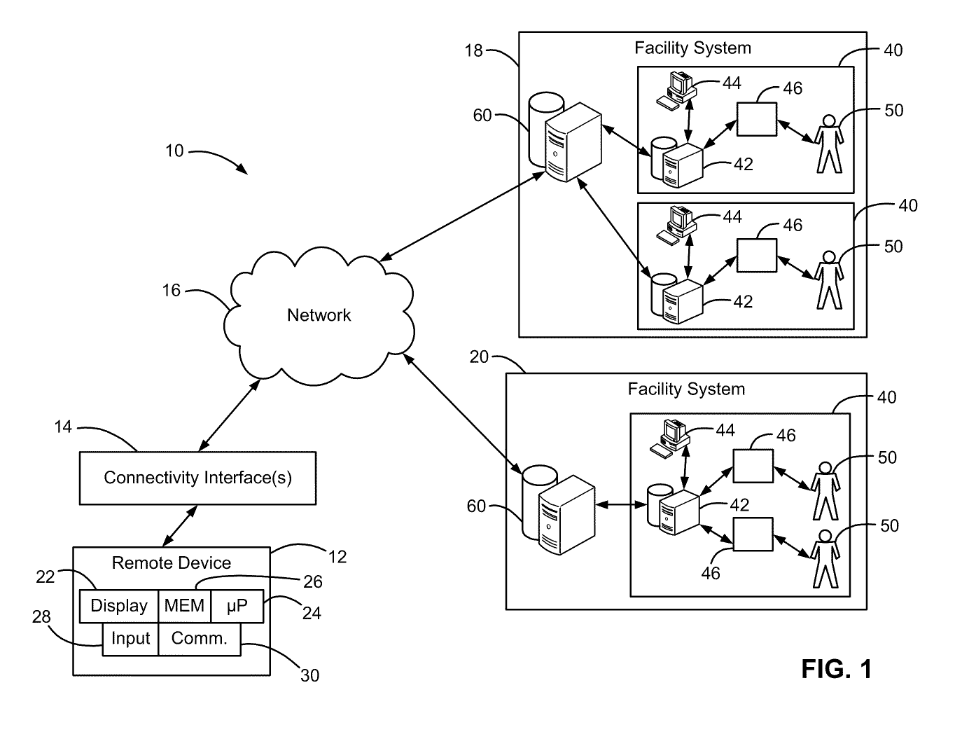

Referring now to FIG. 1, an exemplar system architecture 10 is illustrated, and includes a remote device 12, connectivity interface(s) 14, a network 16, a first facility system 18, and a second facility system 20. As discussed in further detail herein, data is transferred from each of the first and second facility systems 18, 20 through the network 16 and connectivity interface(s) 14 for presentation, or display on the remote device 12. Further, data can be transferred from the remote device 12 through the connectivity interface(s) 14 and network 16 to each of the first and second facility systems 18, 20. Although a single remote device 12 is illustrated, it is contemplated that one or more remote devices 12 can communicate with each of the first and second facility systems 18, through the network 16 and connectivity interface(s) 14. Similarly, although two facility systems are illustrated, the present disclosure can be implemented with one or more facility systems.

The remote device 12 can include any number of exemplar devices. Such exemplar devices include, but are not limited to, a mobile phone, a smartphone, a personal digital assistant (PDA), a laptop, a tablet personal computer (PC), a desktop PC, and/or combinations thereof. The remote device 12 includes a display 22, a processor 24, memory 26, an input interface 28, and a communication interface 30. The processor 24 can process instructions for execution of implementations of the present disclosure. The instructions can include, but are not limited to, instructions stored in the memory 26 to display graphical information on the display 22. Exemplar displays include, but are not limited to, a thin-film-transistor (TFT) liquid crystal display (LCD), or an organic light emitting diode (OLED) display.

The memory 26 stores information within the remote device 12. In some implementations, the memory 26 can include a volatile memory unit or units, and/or a non-volatile memory unit or units. In other implementations, removable memory can be provided, and can include, but is not limited to, a memory card. Exemplar memory cards can include, but are not limited to, a secure digital (SD) memory card, a mini-SD memory card, a USB stick, and the like.

The input interface 28 can include, but is not limited to, a keyboard, a touchscreen, a mouse, a trackball, a microphone, a touchpad, and/or combinations thereof. In some implementations, an audio codec (not shown) can be provided, which receives audible input from a user or other source through a microphone, and converts the audible input to usable digital information. The audio codec can generate audible sound, such as through a speaker that is provided with the remote device 12. Such sound may include, but is not limited to, sound from voice telephone calls, recorded sound (e.g., voice messages, music files, etc.), and sound generated by applications operating on the remote device 12.

The remote device 12 may communicate wirelessly through the communication interface(s) 14, which can include digital signal processing circuitry. The communication interface(s) 14 may provide communications under various modes or protocols including, but not limited to, GSM voice calls, SMS, EMS or MMS messaging, CDMA, TDMA, PDC, WCDMA, CDMA2000, and/or GPRS. Such communication may occur, for example, through a radio-frequency transceiver (not shown). Further, the remote device can be capable of short-range communication using features including, but not limited to, Bluetooth and/or WiFi transceivers (not shown).

The remote device 12 communicates with the network 16 through the connectivity interface(s) 14. The connectivity interface(s) 14 can include, but is not limited to, a satellite receiver, cellular network, a Bluetooth system, a Wi-Fi system (e.g., 802.x), a cable modem, a DSL/dial-up interface, and/or a private branch exchange (PBX) system. Each of these connectivity interfaces 14 enables data to be transmitted to/from the network 16. The network 16 can be provided as a local area network (LAN), a wide area network (WAN), a wireless LAN (WLAN), a metropolitan area network (MAN), a personal area network (PAN), the Internet, and/or combinations thereof.

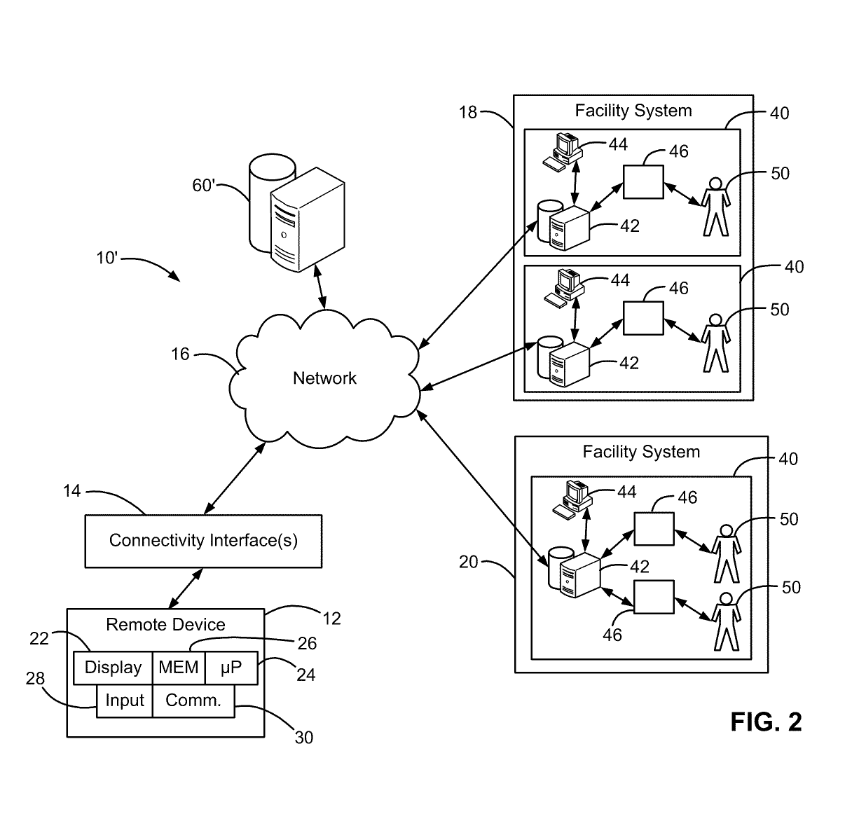

In the exemplar systems of FIGS. 1 and 2, the first facility system 18 includes a plurality of facilities 40, and the second facility system 20 includes a facility 40. It is contemplated that each facility system 18, 20 can include one or more facilities, and is not limited to the exemplar arrangement described herein. In the case of multiple facilities, the facilities can be remotely located from one another, and/or can be located at a common location, or site (e.g., separate departments in a common building). Each facility system 18, 20 can be provided as a medical care system, for example, which medical care system can include one or more hospitals, hospital systems, clinics, physician offices, and the like.

Each facility 40 includes an associated information system 42, computer interface(s) 44, and patient monitoring device(s) 46. Exemplar information systems can include, but are not limited to, a clinical information system (CIS), and/or a hospital information system (HIS). Each information system 42 can be provided as a server, and supports the acquisition, storage, modification, and distribution of clinical information, such as patient data, throughout the facility 40 and/or facility system 18, 20. Exemplar information systems include, but are not limited to, the Integriti Enterprise Wide CIS, the QS Perinatal CIS, and/or the QS Critical Care CIS, each provided by General Electric (GE), the OBiX Perinatal Data System provided by Clinical Computer Systems, Inc., the IntelliVue Clinical Information Portfolio (ICIP), Critical Care and/or OB TraceVue Perinatal Data System provided by Royal Philips Electronics, the Essentris Perinatal, Acute Care and/or Critical Care systems provided by CliniComp International, Inc., the CALM Perinatal Data System provided by LMS Medical Systems, the Horizon Lab, Medical Imaging, Cardiology, Emergency Care and/or Perinatal Care provided by McKesson Corporation, and/or the NaviCare WatchChild System provided by Hill-Rom. Each information system 42 can communicate with one or more ancillary information systems (not shown) that can include, but are not limited to, a pharmacy management system, a laboratory management system, and/or a radiology management system. Although the exemplar system architecture 10 includes an information system 42 located at each facility 40, it is contemplated that the facilities 40 can communicate with a common information system 42 that is remotely located from either facility 40, or that is located at one of the facilities 40 within the facility system 18, 20.

The computer interface 44 can communicate with the information system 42 to enable access to information that is stored within, and managed by the information system 42. The computer interface 44 can include, but is not limited to, a personal computer (PC) (e.g., desktop, laptop, or tablet). Although a single computer interface 44 is illustrated in the exemplar architectures described herein, it is contemplated that one or more computer interfaces 44 can communicate with the information system 42. Communication between each computer interface 44 and the information system 42 can be achieved via a direct connection, or remotely through a network (not shown) that can include, but is not limited to, a LAN, a WAN, a WLAN, and/or the Internet.

Each patient monitoring device 46 monitors physiological characteristics of a particular patient 50, and generates data signals based thereon. Exemplar patient monitoring devices include, but are not limited to, maternal/fetal heart rate monitors, blood pressure monitors, respiratory monitors, vital signs monitors, electrocardiogram monitors, oximetry and/or anesthesia monitors. Exemplar patient monitoring devices can include, but are not limited to the Corometric Series Monitors, DINAMAP Series Monitors, DASH Series Monitors, and/or Solar Series monitors provided by GE Healthcare, IntelliVue and/or SureSigns Series patient monitors, and/or Avalon Series Fetal Monitors provided by Royal Philips Electronics, and/or Infinity Series patient monitors provided by Draeger Medical. The data signals are communicated to the information system 42, which collects patient data based thereon, and stores the data to a patient profile that is associated with the particular patient. Although a single patient monitoring device 46 is illustrated per each patient 50, it is contemplated that multiple patient monitoring devices 46 can monitor a particular patient 50. The patient monitoring device(s) 46 can communicate with the information system 42 via a direct connection, or remotely through a network (not shown) that can include, but is not limited to, a LAN, a WAN, a WLAN, and/or the Internet.

The patient data is made available for display on the computer device 44. A healthcare provider (e.g., a nurse and/or physician) can augment the patient data by inputting patient information that is also stored to the information system 44. More specifically, the healthcare provider can input patient information corresponding to a particular patient 50, which patient information can be stored to the patient profile. By way of one non-limiting example, a nurse can input nursing notes, which nursing notes can be stored to the patient profile in the information system. As used herein, the term patient information includes any information corresponding to a patient that is input and stored to the information system 42 through the computer interface 44. Patient information is discussed in further detail below.

As discussed above, each information system 42 stores patient data that can be collected from the patient monitoring devices 46, as well as additional patient information, that can include information that is input by a healthcare provider. The information system 46 communicates the patient data and/or the additional patient data to a data management system (DMS) 60. The DMS 60 can be provided as a server, or a virtual server, that runs server software components, and can include data storage including, but not limited to, a database and/or flat files. In the exemplar system architecture of FIG. 1, each facility system 18, 20 includes a corresponding DMS 60. In such an arrangement, each information system 42 communicates patient data, and/or additional patient data to the DMS 60. Furthermore, and as discussed in further detail below, the DMS 60 can communicate ancillary information to the information system 42. Communication between the DMS 60 and the information system(s) 42 can be achieved via a direct connection, or remotely through a network (not shown) that can include, but is not limited to, a LAN, a WAN, a WLAN, and/or the Internet.

A DMS 60 corresponding to a particular facility system can be remotely located from any of the facilities 40 of the facility system 18, 20, or can be located at a particular facility 40 of the facility system 18, 20. In the exemplar system architecture of FIG. 1, the DMS 60 is remotely located from either facility 40 within each of the facility systems 18, 20. It is contemplated, however, that the DMS 60 can be located at one of the facilities 40, and remote from the other facility 40.

In the exemplar system architecture of FIG. 2, a common DMS 60′ is provided. The common DMS 60′ is common to various facility systems 18, 20, and is not associated with a particular facility system 18, 20. Each information system 42 communicates with the DMS 60′ via a direct connection, or remotely through a network (not shown) that can include, but is not limited to, a LAN, a WAN, a WLAN, and/or the Internet. In the exemplar arrangement of FIG. 2, the DMS 60′ communicates with each of the information systems 42 through the network 16. The information systems 42 communicate patient data and/or patient information to the DMS 60′, and the DMS 60′ can communicate ancillary information to the information system 42, as discussed in further detail below.

In the exemplar system architecture of FIG. 1, the facility 40, or facility system 18, 20 installs the DMS 60 as a local DMS, and the DMS 60 sits at the local site with other servers that can include, but are not limited to, the information system 42. In some implementations, the DMS 60 can be sectioned off, or separated from a logical network perspective, but still physically exists with the other servers that belong to the respective facility 40. Server components are installed on the DMS 60, which components can include, but are not limited to, a database component, a database synchronization component, a web services component, and/or a structured query language (SQL) component. An information system interface can also be installed on the DMS 60, and functions as the interface to the information system 42. By way of non-limiting example, the information system interface can include OBLink, provided by GE Healthcare. In some implementations, the DMS 60 can be arranged in a multiple server configuration, in which one server only hosts web service related components and is logically segregated, and another server has the remaining necessary server components installed.

The exemplar system architecture of FIG. 2, provides for the remote location of data collection at the DMS 60′. In such implementations, the DMS 60′ can be provided at a third-party site, remote from any of the facilities 40, or facility systems 18, 20. The third-party functions as a DMS host, and the necessary server components are installed on the remotely hosted DMS 60′. In some implementations, a business-to-business (B2B) virtual private network (VPN) can be created between the remotely hosted DMS 60′ and the network of the facility 40 or facility system 18, 20. In this manner, the facility 40 and/or facility system 18, 20 forgoes the purchase and/or maintenance of another physical server, or DMS 60. Further, the up-time and the status of availability of the DMS 60′ are easier to manage on the part of a dedicated third-party. The DMS' access to the network can be attended to by the third-party, as opposed to burdening the facility 40, or the facility systems 18, 20. Further, the third-party can implement virtual server technologies to leverage multiple DMS installations on a single physical server. In such implementations, a plurality of virtual servers are logically partitioned in a single physical server, and each virtual server has the capability of running its own operating system and server components, and can be independently booted.

The DMS 60, 60′ synchronizes and transfers data between the remote device 12, or multiple remote devices 12, and the information system 42, or multiple information systems 42. More specifically, the DMS 60, 60′ processes and prepares the patient data and/or patient information for transfer to and presentation on the remote device 12, or multiple remote devices 12, from the information system 42. The DMS 60, 60′ also processes and prepares ancillary information for transfer to and storage in the information system 42 from the remote device 12, or multiple remote devices 12 for potential presentation at a corresponding computer device 44. Exemplar DMSs can include, but are not limited to, the AirStrip Server provided by AirStrip Technologies, LLC, which AirStrip Server includes AirStrip Server Components installed therein.

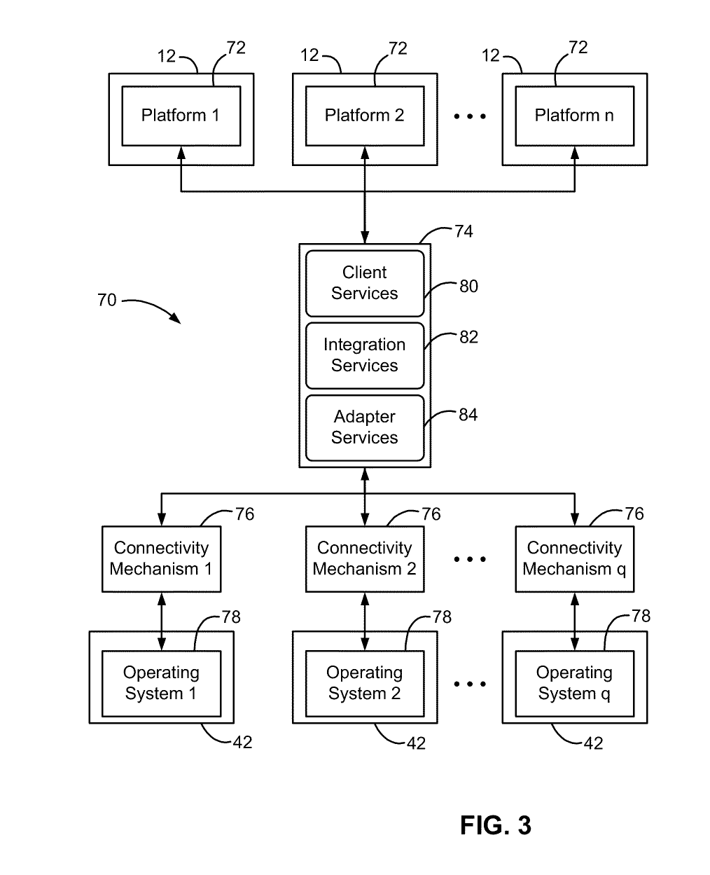

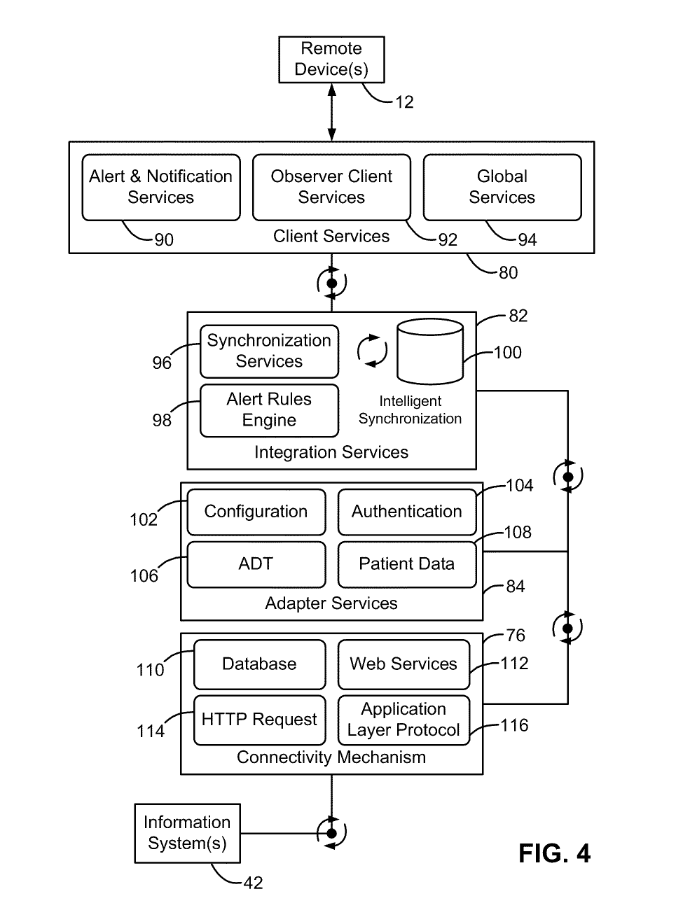

Referring now to FIGS. 3 and 4, an exemplar software component, or module structure 70 to implement the features of the present disclosure will be described in detail. The exemplar structure enables patient data and patient information to be communicated to/from, and to be synchronized between the information system 42 and the remote device 12, regardless of the operating system, or platform, operating on the remote device 12. Exemplar platforms include, but are not limited to, RIM Blackberry, Apple iPhone, MS Pocket PC 2003, Win Mobile 5.x (Pocket PC, Smartphone), Win Mobile 6.x (standard, professional) and/or any platforms to be developed (e.g., Google Android, and Palm PRE).

FIG. 3 illustrates an overview of the exemplar module structure 70, which includes a platform 72, or operating system, of the remote device 12, intermediary components 74, a connectivity mechanism 76, and an operating system 78 of the information system 42. In this arrangement, the remote device 12 is a client that executes a client application thereon. The intermediary components 74 are resident on the DMS 60, 60′, and include a client services module 80, an integration services module 82, and an adapter services module 84. The DMS 60, 60′ functions as an intermediary between the platform 72 resident on the remote device 12 and the operating system 78 of the information system 42. A plurality of platforms 72 is illustrated to exemplify the ability of the DMS 60, 60′ to transfer data to and from any platform 72 operating on the remote device 12. The connectivity mechanism 76 enables communication between the DMS 60, 60′ and a particular information system 42. A plurality of connectivity mechanisms 76 and corresponding operating systems 78 is illustrated to exemplify the ability of the DMS 60, 60′ to transfer data to and from any operating system 78 on the information system 42.

In the exemplar structure illustrated in FIG. 4, the client services module 80 includes an alert and notification services module 90, an observer client services module 92, and a global services module 94. The integration services module 82 includes a synchronization services module 96, and an alert engines rule 98. The synchronization services module 96 can communicate with a synchronization database 100 to provide so-called intelligent synchronization. The adapter services module 84 includes a configuration module 102, an authentication module 104, an admission, discharge and transfer (ADT) module 106, and a patient data module 108.

The alert and notification services module 90 sends alerts and/or notifications to the remote device 12, as discussed in further detail below. The observer client services module 92 facilitates communication between client applications, running on the remote device 12, and backend server components that provide access to application data. The observer client services module 92 transmits data through a formatted request, and receives data in a proprietary data format. An exemplar data format includes, but is not limited to, JavaScript Object Notation (JSON), which is a lightweight computer data interchange format that provides a text-based, human-readable format for representing simple data structures and associative arrays, called objects). The global services module 94 communicates with the client running on the remote device 12 and performs registration and client application configuration settings. Client application settings can be customized by the user of the remote device 12, and the facility 40 and/or facility systems 18, 20, for which the remote device 12 is configured to receive data.

The integration services module 82 is responsible for routing requests that are received from the observer client services module 92 to retrieve and package requested data, and to send a corresponding response. More specifically, the integration services module 82 requests data from the adapter services module 84, or from the synchronization database 100 depending on how the particular DMS 60, 60′ is configured. If the DMS 60, 60′ is configured to use a vendor adapter, the request goes directly to the adapter services module 84 to retrieve the data. If the DMS 60, 60′ is configured for synchronization, then the data is retrieved from the synchronization database 100. The synchronization services module 96 communicates with the adapter services module 84 to maintain the synchronization database 100 current using intelligent synchronization.

Intelligent synchronization is synchronization executed based on variable configuration parameters, which enable the possibility of only some of the patient data and/or patient information to be synchronized as opposed to all of the available data being continuously synchronized. By using custom business rule logic to intelligently determine which patient data and/or information should be synchronized, and which patient data and/or information should be synchronized, the DMS 60, 60′ functions more efficiently and can service an increased number of clients and configurations. By way of non-limiting example, prior to a user logging on to the DMS 60, 60′ via the remote device 12, no specific patient data and/or information is synchronized. Instead, only a patient census list and specific data elements corresponding to particular patients 50 are synchronized between the DMS 60, 60′ and the information system(s) 42. Once the user logs on, and selects a particular patient 50 to review, the synchronization services begin synching all of the available patient data and/or information for that particular patient 50. Consequently, subsequent reviews of the particular patient 50 are much faster, because the patient data and/or information has been synchronized.

The adapter services module 84 is the mechanism that retrieves data from the information system 42, through the connectivity mechanism module 76, and that structures the data for the DMS 60, 60′. The data is formatted and rules are applied for the specific DMS 60, 60′, for which the adapter has been written, regardless of whether the data is directly requested for a client through the integration services module 82, or is retrieved through the synchronization services module 96. The configuration module 102 captures configuration settings used by the information system(s) 42. The configuration module 102 can use already existing configuration information so that it does not have to be replicated in the DMS 60, 60′. By way of non-limiting example, all of the patient beds of a particular facility 40, and to which unit(s) they belong are typically stored in the information system(s) 42. The configuration module 102 reduces, or obviates manual effort in entering the configuration information. The configuration module 102 can also prevent problems from occurring when a configuration change is made in the information system(s) 42, but a system administrator forgets to make the change in the DMS 60, 60′.

The authentication module 104 handles the authentication needs of the DMS 60, 60′, which can include, but are not limited to active directory authentication, vendor authentication, device ID restrictions, device phone number restrictions, and any combination thereof. Each facility system 18, 20 and/or facility 40 is configured to authenticate using any combination of such authentication mechanisms. Device ID restriction is the ability for an authentication service to look at a pre-configured list of device ID's, associated with respective remote devices 12, that are authorized to connect to the facility system 18, 20 and/or facility 40, and only authorizes call from software client that originate with that device ID (i.e., from the particular remote device 12). The device phone number restriction restricts access to remote devices 12 that have a phone number that has been pre-configured in the authentication system.

The ADT module 106 enables the use of existing ADT interfaces within the facility system 18, 20 and/or facility 40 to obtain patient admission, discharge and transfer information in order to always know which patient is associated to which bed and/or unit. The patient data module 108 provides all waveform and non-waveform patient data and/or information from the information system(s) 42 to the DMS 60, 60′. The patient data module 108 can also provide all waveform and non-waveform acquired from a data acquisition system such as the AirStrip data collector or an independent data collecting system including but not limited to Capsule Technologies' Data Captor system. This includes, but is not limited to, all nursing charting information as well as any automated means of data collection used by the information system(s) 42.

In the exemplar structure illustrated in FIG. 4, each connectivity mechanism module 76 includes a database module 110, a web services module 112, a request module 114, and an application layer protocol module 116. By way of non-limiting example, the request module 114 can manage HTTP requests, and/or the application layer protocol can include the health level seven (HL7) application layer protocol. The connectivity mechanism module 76 enables the DMS 60, 60′ to connect to and communicate with the particular information system 42. In some implementations, the connectivity mechanism module 76 can include application protocol interfaces (APIs), through which it communicates with the information system 42. In other implementations, the connectivity mechanism module 76 can directly access the information system 42.

As discussed at the outset, the present disclosure provides a healthcare provider, or user of the remote device 12, with secure, remote access to patient data and/or patient information. As used herein, the term patient data refers to physiological data that can be obtained from the patient monitoring device(s), and/or physiological patient data that is input into the information system 42 by a local healthcare provider (e.g., a nurse, or physician). The term patient information refers to information corresponding to a particular patient that is input into the information system 42 by the local healthcare provider. Exemplar patient information can include, but is not limited to, the patient's name, the name of the doctor(s) assigned to the patient, the nurse(s) assigned to the patient, a facility identification, a patient bed identification, a summary of key patient data, and/or chart annotations. In the exemplar case of a maternity patient, the key patient data can include, but is not limited to, delivery progress information such as cervical exam status, membrane status, gravida, para, epidural status, and/or whether the patient is attempting a vaginal birth after cesarean (VBAC).

The patient data and/or patient information provided to the remotely located user can be provided in real-time data, and/or as historical data and information. The patient data and/or patient information is communicated between the remote device 12 and the DMS 60, 60′ using a secure connection that is established over the network 16. A secure log-in, or sign-on process is provided, which is preferably compliant with the provisions of the Health Insurance Portability and Accountability Act (HIPAA). The secure sign-on authenticates the identity of the user of the remote device 12 based on a unique user ID and password combination. Both the user ID and the password must be correct in order to establish the secure communication between the remote device 12 and the DMS 60, 60′. Implementations of sign-on and authentication processes are described in further detail below.

A census, or patient list is provided to the remote device 12, which captures a variety of the information and/or data described herein that is associated with each of one or more monitored patients 50. Strip charting is also provided, in which patient data and/or information can be presented to the user in graphical form. In the exemplar case of a maternity patient, a fetal strip and maternal contraction information can be provided for a particular patient 50. More specifically, the particular patient 50 is selected from the patient list, and the patient information and/or data is subsequently presented. The presented information and/or data can include a fetal strip and maternal contraction waveform, the patient name, the hospital name, the patient room and/or bed number, and the date and time. The strip charting can provide a real-time view of the patient data, as well as a historical view of the patient data. More specifically, the waveform display can be updated in real-time, such that the user of the remote device 12 observes the patient data as it occurs and/or is recorded. The user can scroll through the waveform display, to view historical patient data, as described in further detail below.

Several navigation features can be provided that enable the user to manipulate a view of the waveform display. In some implementations, the user can zoom in/out of the displayed image. In this manner, the user can view very specific waveform information, and/or other waveform micro-characteristics by zooming in, for example, and/or can view patterns or other waveform macro-characteristics by zooming out, for example. In some implementations, the user can scroll forward or backward through the waveform display. In this manner, the user can view historical patient data.

A patient data display can also be provided. In some implementations, the patient data display can overlay the strip charting described herein. In other implementation, the patient data display can be provided as an overlay, and/or as a separate display. The patient data display can include, but is not limited to, the patient's name, age, fetal gestation, gravida, parity, cervical exam information, and physician name.

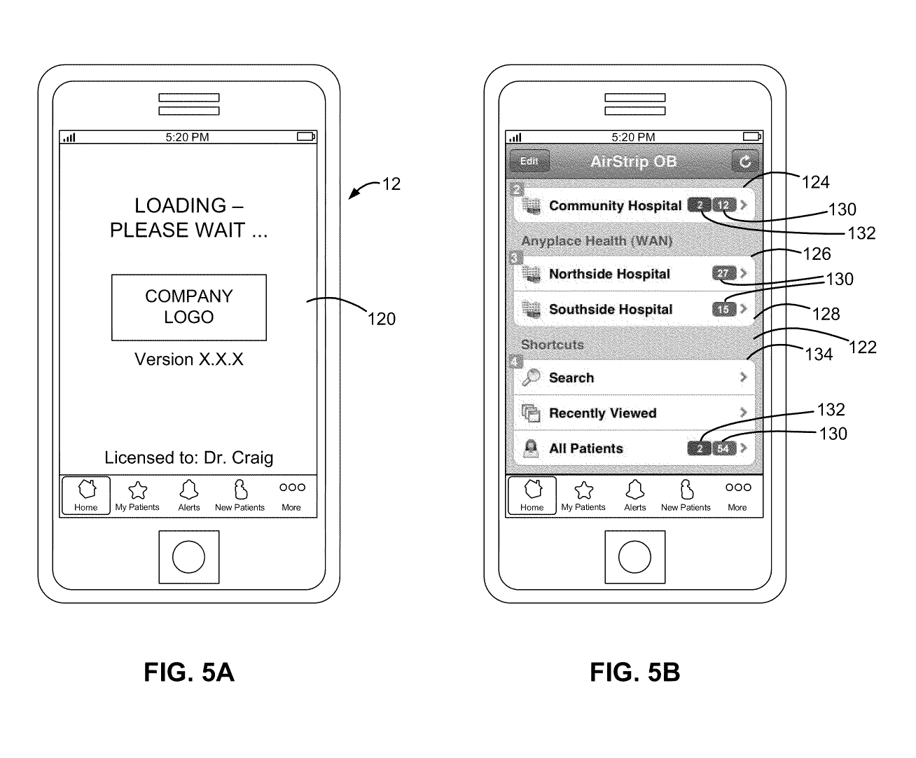

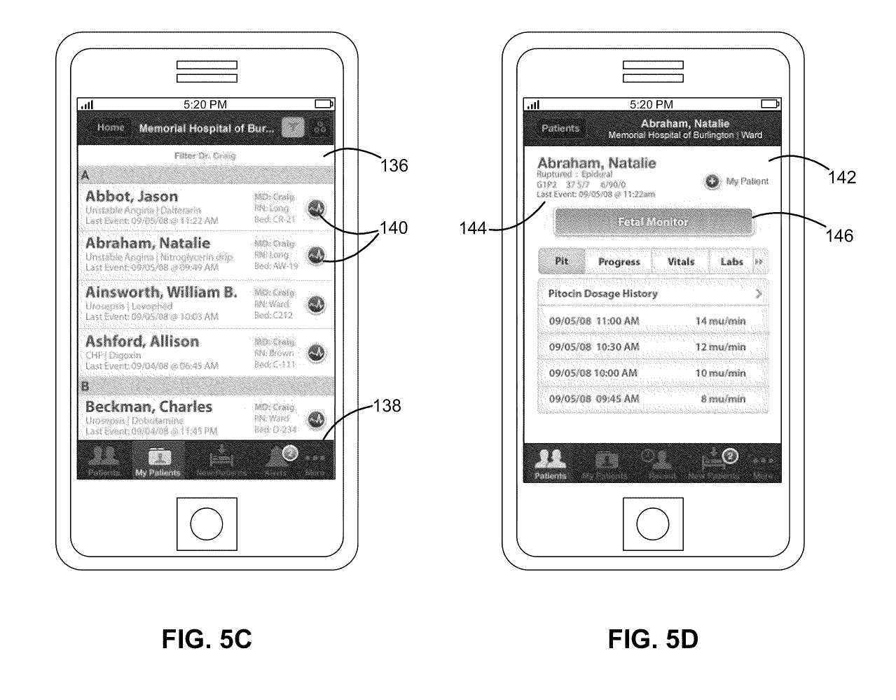

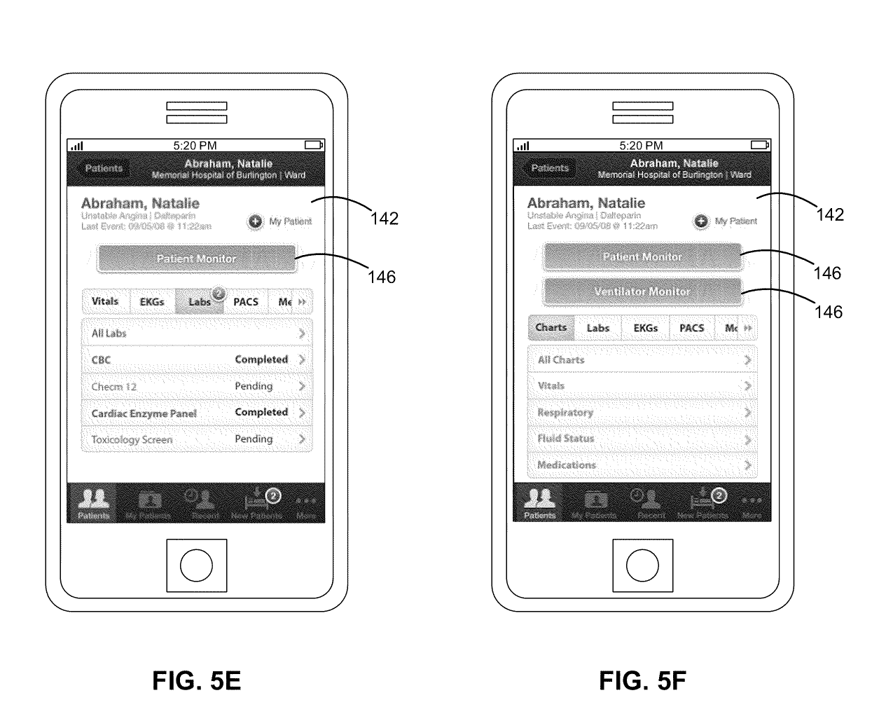

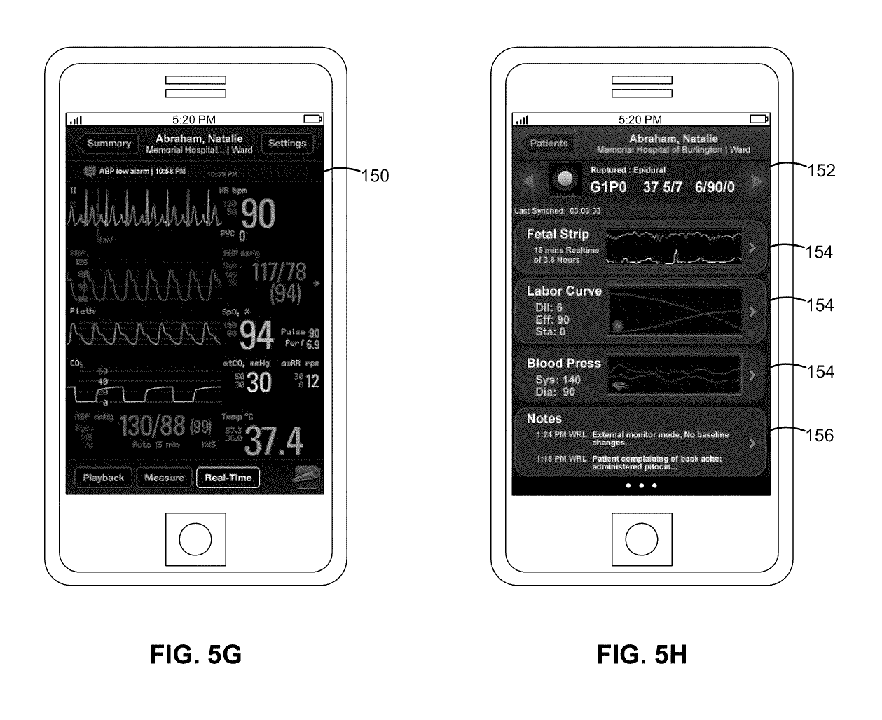

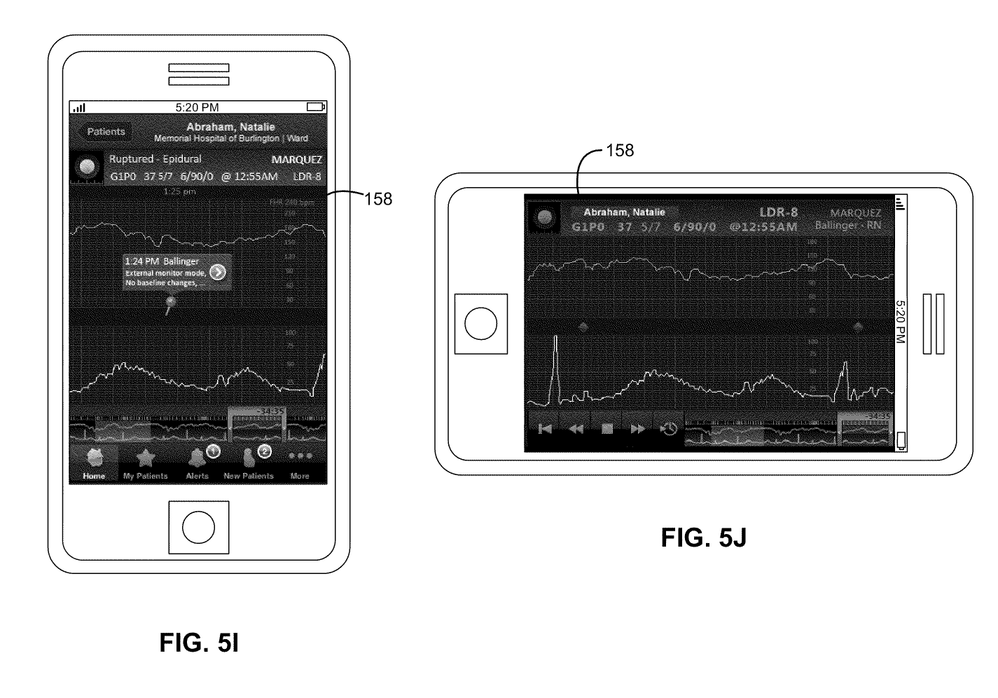

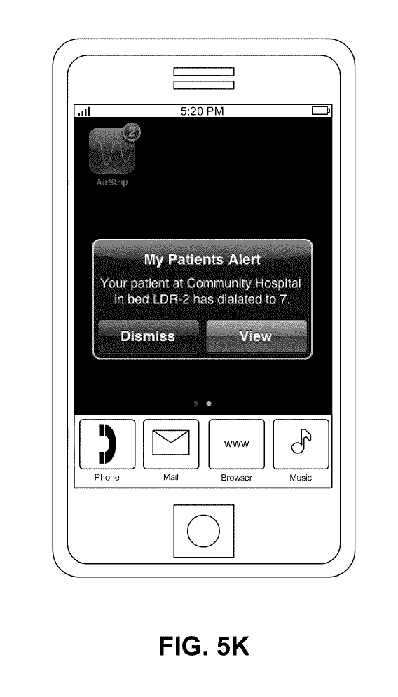

Implementations of the present disclosure can be realized on any one of a number of operating systems, or platforms 72 associated with the particular remote device 12. As discussed above with reference to FIGS. 3 and 4, exemplar platforms include, but are not limited to, RIM Blackberry, Apple iPhone, MS Pocket PC 2003, Win Mobile 5.x (Pocket PC, Smartphone), Win Mobile 6.x (standard, professional) and/or any platforms to be developed (e.g., Google Android, and Palm PRE). Referring now to FIGS. 5A-5K exemplar implementations of the present disclosure will be described with reference to screen-shots of an exemplar remote device 12. The remote device 12 of the instant example includes a mobile device, such as a cellular telephone, or smartphone, that includes an exemplar platform (e.g., Apple iPhone). It is appreciated, however, that implementations of the present disclosure can be executed on any type of remote device 12, and/or using any type of platform 72 that is supported by the remote device 12. It is appreciated that the screen-shots illustrated and described herein are merely exemplar in nature, and are not exhaustive of the functionality and features provided in implementations of the present disclosure.

FIG. 5A illustrates an exemplar screen-shot of a loading screen 120 that is initiated after the user inputs a user ID and password combination. If the user ID and password combination is authenticated, secure communication between the remote device 12 and the DMS 60, 60′ is established, and the remote device 12 retrieves patient data and/or information from the DMS 60, 60′. In some implementations, the user may be associated with more than one facility system 18, 20, with each facility system 18, 20 including its own DMS 60 (see, for example, FIG. 1). In such cases, secure communication between each of the DMS 60 and the remote device 12 is established upon the confirmation of the user ID and password combination, as explained in further detail herein.

FIG. 5B illustrates an exemplar screen-shot of a facility summary display 122 that provides a summary of the facility system(s), and/or particular facility, or facilities, with which the user is associated. The facility summary display 122 includes a plurality of selectable icons. The exemplar illustration of FIG. 5B provides a facility icon 124 (e.g., “Community Hospital”), and a facility system (e.g., “Anyplace Health (WAN)”) that includes two facility icons 126, 128 associated therewith (e.g., “Northside Hospital,” and “Southside Hospital”). The facility (e.g., “Community Hospital”) can be a stand-alone facility that is not associated with a facility system (e.g., “Anyplace Health (WAN)”). In this case, the facility can be described as “non-WAN”, because it is not networked with other facilities, and/or a facility system. The facility system can be described as “WAN,” because it is a facility system that includes a plurality of inter-communicating facilities associated therewith.

With particular reference to the facility system icons 126, 128, attributes can be provided. Exemplar attributes can include, but are not limited to, patient counts. A first patient count 130 provides the total number of patients at the facility, for which the particular user is responsible. For example, if the user is a physician, the first patient count 130 illustrates the total number of patients that are under the care of that particular physician. In the exemplar illustration of FIG. 5B, the total number of patients associated with the user at “Community Hospital” is twelve, the total number of patients associated with the user at “Northside Hospital” is twenty seven, and the total number of patients associated with the user at “Southside Hospital” is fifteen. A second patient count 132 can be provided, which displays a specific patient count. The specific patient count can include the number of patients deemed to be new patients. In the exemplar illustration of FIG. 5B, a specific patient count of two is associated with the “Community Hospital.” This can indicate, for example, that of the twelve patients at “Community Hospital,” two are deemed to be new patients.

The exemplar facility summary display of FIG. 5B further includes a shortcut menu 134 that provides links to exemplar functions, and/or other displays. Although the illustrated exemplar links include “Search,” “Recently Viewed,” and “All Patients,” it is contemplated that the shortcut menu 134 can be customized by the user to provide any available links that the user desires. By selecting “Search,” a search screen is provided, in which the user can input search terms to search for patients, facilities, facility systems, and the like. By selecting “Recently Viewed,” a display screen is provided, in which a number of patients, whose patient data has been recently viewed by the user using the remote device are listed. By way of non-limiting example, the list of patients can be determined by a fixed count (e.g., the last X number of patients that the user has viewed), and/or can be determined by a time (e.g., the patients viewed by the user over the last X day(s)). By selecting “All Patients,” a display screen is provided, which lists all of the patients that are assigned to the specific user, regardless of facility or facility system. The “All Patients” link can also include a total patient count 130, and a specific patient count 132. In this case, the total patient count 130 within the shortcut menu 134 indicates the number of patients that are under the care of that particular user, regardless of the facility, and the specific patient count 132 can indicate the number of new patients of the total.

The user can navigate from the facility summary display 122 by selecting any one of the icons. An icon can be selected in any one of a number of manners that is supported by the particular platform. By way of non-limiting examples, an icon can be selected by touching the screen with a digit (i.e., finger), a stylus, and/or other pointing device, as well as with a digital cursor, and/or a keypad.

FIG. 5C illustrates an exemplar screen-shot of a patient summary display 136 that provides a summary of the patients associated with a particular facility (e.g., “Memorial Hospital” in the exemplar illustration of FIG. 5C). The summary can include patient data and/or information. In the exemplar illustration of FIG. 5C, the summary information includes the patient's name, the attending nurse's name, the responsible physician's name, the patient's bed number, the date and time of the most recent, or last, medical event, a condition (e.g., “Unstable Angina,” “Urosepsis,” and/or “Congestive Heart Failure (CHF)”), as well as a particular medication prescribed to the patient. A particular summary type can be selected from a menu 138. In the exemplar illustration of FIG. 5C, the menu 138 is provided as a touch screen menu, and includes a plurality of selectable options. It is contemplated, however, that the menu 138 can be provided in any one of a number of manners including, but not limited to, a drop-down menu. The illustrated, exemplar options of the menu 138 include “Patients,” “My Patients,” “New Patients,” “Alerts,” as well as the option “More” to display additional options. In the exemplar illustration of FIG. 5C, the patient summary display 136 lists the patients associated with the particular user (e.g., “Dr. Craig”) at the particular facility (e.g., “Memorial Hospital”). By selecting “Patients,” all of the patients at the particular facility can be displayed. By selecting “New Patients,” only those patients that are deemed to be new patients are displayed. By selecting “Alerts,” patients having a corresponding alert status, discussed in further detail herein, are displayed. A selectable chart 140 icon can also be provided for each patient listed. By selecting the chart icon, one or more graphical strip charts of patient data and/or patient information can be displayed, as discussed in further detail below.

By selecting a particular patient from the patient summary display 136, a specific patient summary display 142 is provided. FIG. 5D illustrates an exemplar specific patient summary display 142 for the patient “Abraham, Natalie” selected from the patient summary display 136. The specific patient summary display 142 can provide a variety of summarized patient data and/or information 144. The specific patient summary 142 further includes selectable icons for drilling down to more specific patient information. For example, a monitor icon 146 can be provided, which enables the user to view graphical strip charts of patient data and/or patient information, as discussed in further detail below. In the exemplar context of a maternity patient, the selectable icon is provided as a “Fetal Monitor” icon. Other patient data and/or information can be viewed on the specific patient summary display. In the exemplar illustration of FIG. 5D, a selectable menu is provided, through which the user can select particular summary data and/or information to view. The exemplar options illustrated in FIG. 5D include, but are not limited to, a medication dosage history, a progress history, vitals, and laboratory results. FIGS. 5E and 5F illustrate other, exemplar specific patient summary displays 142 that include other monitor icons 146 (e.g., “Patient Monitor,” and “Ventilator Monitor”), as well as other available summary data and/or information (e.g., electrocardiograms (ECGs or EKGs), charts, and PACS).

Referring now to FIG. 5G, an exemplar screen-shot of a patient vital display 150. The patient vital display 150 can provide patient data values and/or can display the patient data graphical form (e.g., as a strip). In the exemplar illustration of FIG. 5G, values of patient vitals are provided, and the patient vitals are shown in graphical form. The exemplar patient vitals include, but are not limited to, heart rate, blood pressure, oxygen saturation, end-tidal CO₂, Swan tracing, Arterial Line Tracing, Central Venous Pressure, EKG/ECG, Ventilator waveforms and body temperature. The patient vitals can be provided as a static display, can be displayed in real-time (i.e., updated as measurements are taken by the patient monitoring device(s)), and/or can be played back (i.e., playback stored patient data to provide a historical display).

FIG. 5H illustrates an exemplar screen-shot of a patient display 152, which display summary strips 154 associated with particular patient data. In the exemplar context of a maternity patient, the display summary strips 154 include, but are not limited to a fetal strip, labor curve, and blood pressure. A note summary 156 can also be provided. By selecting one of the display summary strips 154, the corresponding strip can be displayed in more detail, as described below with respect to FIGS. 5I and 5J. By selecting the note summary 156, nursing notes and information pertinent to the particular patient can be displayed to provide specific detail.

The exemplar implementations of FIGS. 5I and 5J provide a fetal strip 158. It is appreciated, however, that implementations of the present disclosure can display any type of pertinent data strip including, but not limited to, a fetal strip, a labor curve, blood pressure, heart rate, oxygen saturation, end-tidal CO₂, Swan tracing, Arterial Line Tracing, Central Venous Pressure, EKG/ECG, Ventilator waveforms and/or body temperature. The exemplar illustration of FIG. 5I provides the fetal strip in a portrait layout, and the exemplar illustration of FIG. 5J provides the fetal strip in a landscape layout. The landscape layout enables the user to either view a greater amount of patient data over a longer time period, or view the patient data in expanded detail across the same time period.

Upon selecting the particular strip for display, a request is made from the remote device 12 to the corresponding information system 42 to transmit the patient data and/or information for the particular patient. The patient data and/or information is provided to the remote device 12, with the remote device 12 buffering the patient data and/or information to provide real-time viewing thereof. Basic real-time viewing of the patient data is provided on a background grid with a timing mark shown and patient information being provided. In implementations of the present disclosure, the patient data trace moves from right to left across the display.

In implementations of the present disclosure, provide zoom in and out functionality. In each case, the user can take advantage of viewing a trend (e.g., zoom out), or a specific data segment (e.g., zoom in) to facilitate a judgment with regard to the condition of the patient. Implementations of the present disclosure also provide variable speed scroll functionality of the data strip. More specifically, the user of the remote device 12 can be presented with a bi-directional, multilevel selection bar, and/or virtual controls that regulate the direction and the scrolling speed of the data strip. In this manner, the user can customize viewing of the patient data to personal preferences, or to the specific situations that dictate review of the patient data. For example, the user may quickly scroll through the data strip to a point, at which a particular anomaly occurred, and can more slowly scroll the data strip around that point to study the patient data in further detail.

With particular reference to FIG. 5I, an annotation can be included in the data strip, or waveform. The annotation can be provided as patient information that is downloaded from the information system 42 through the DMS 60, 60′. For example, and as discussed in further detail above, a local healthcare provider (e.g., a nurse and/or physician at the facility 40) can input patient information using the computer interface 44 including annotations, among others. Such annotations are transmitted to the local device 12 as patient information, and can be presented on the data strip. The annotation can correspond to a specific data point, data segment, and/or time period. The annotation display can initially include a small, selectable summary display that overlays the data strip. Upon selection, the summary display can expand to provide full details of the annotation.

As discussed immediately above, the user can view annotations on the waveform (e.g., fetal strip) that are input at the facility 40. Such annotations can include, but are not limited to, nursing notes, for example. In such cases, the annotations can be manual annotations that originate from an attending nurse, who enters the annotation through the information system 42, typically through the computer device 44 (e.g., a PC client). It is also contemplated, that some annotations can be automatically entered by the information system 42. Such annotations can include, but are not limited to, blood pressure and/or heart rate, that are automatically generated by a corresponding patient monitoring device 46.

Implementations of the present disclosure enable the user to annotate the waveform, or strip using the remote device 12. More specifically, the user can input ancillary information that is subsequently transferred from the remote device 12 to the information system 42 through the DMS 60, 60′. Such ancillary information can include, but is not limited to, annotations (e.g., user notes), digital images (e.g., x-rays, photographs, drawings, sketches), digital video, audio and/or electronic documents. The ancillary information is processed and formatted through the DMS 60, 60′ for subsequent display at the facility 40. More specifically, the ancillary information generated on the remote device 12 can be stored to the information system 42 for subsequent display on the computer interface 44. In this manner, the remotely located user can provide feedback, and/or any other necessary information to local healthcare provider.

By way of one non-limiting example, the user can record a voice note using a microphone of the remote device 12, which voice note is stored in memory of the remote device 12. The voice note can be communicated from the remote device 12 to the information system 42 for subsequent access to the voice note at a particular facility 40 or facilities 40. By way of another non-limiting example, the user can record a video that can include an associated audio component, using a video camera and microphone of the remote device 12, which video is stored in memory of the remote device 12. The video can be communicated from the remote device 12 to the information system 42 for subsequent access to the video at a particular facility 40 or facilities 40. By way of still another non-limiting example, the user can generate an image, such as a photograph, using a camera of the remote device 12, which image is stored in memory of the remote device 12. The image can be communicated from the remote device 12 to the information system 42 for subsequent access to the image at a particular facility 40 or facilities 40.

In some implementations, the user can initiate the opening of a dialog box within the display of the remote device 12. The dialog box can provide the user with options for inputting ancillary information, and to associate, or link such ancillary information to a particular patient data point, or segment on the waveform. For example, the dialog box can enable the user to type in notes, choose from a list of pre configured commonly used annotation choices, and/or upload digital images (e.g., x-rays, photographs, drawings, sketches), digital video, audio and/or electronic documents.

With particular reference to FIG. 5K, implementations of the present disclosure enable alerts to be generated based on monitored patient data. More specifically, alert settings can be configured by the user on the remote device 12, and/or at the facility 40 (e.g., create an alert using the computer interface 44). Each alert setting can define particular criteria, constraints and/or thresholds that, if met, generate an alert at the remote device 12, and/or the facility 40. More specifically, values of the patient data and other information pertinent to a particular alert are monitored at the facility 40. When the values in the patient data have changed or meet a certain criteria, an alert is generated at the facility 40 and/or the local device 12. Other alert functionality can include a “My Alerts” option can be provided as a global option to turn all alerts on/off (e.g., the user will not be notified, if the user is not on call).

The alert can be indicated to the user of the local device 12 in any number of available manners. For example, a visual indication can be presented on the display, an audible indication can issue from the remote device 12, and/or the remote device 12 can be induced to vibrate. The relative importance of the alert can be set by the user, and can be reflected by the type of indication. By way of non-limiting example, a very important alert can be visually, audibly, and physically (e.g., vibration) indicated. An alert of less importance may only include a visual indication, for example.

In some implementations, the alert(s) can be configured by the user at the remote device 12, and can be registered with the DMS 60, 60′ through the alert rules engine module 98 in the integration services module 82 (see FIG. 4). In some implementations, the alert(s) can be constrained to the remote device 12. For example, the user can configure an alert that is not registered with the DMS 60, 60′, or the information system 42. Instead, the alert is only resident on the remote device 12.

The alert functionality also enables the user to configure and customize constraints around available alerts such that they are tailored to that user's needs. Some of such alerts can originate from the information system 42, and others can originate from the DMS 60, 60′, which is collecting and monitoring the patient data from the information system 42.

Exemplar patient alerts can include, but are not limited to, a new patient alert, a patient status alert, a patient discharge alert, and/or a request alert. The new patient alert can include an alert that notifies the user of a new patient that they have been assigned to his/her care. In some implementations, a user name can be input as part of the patient information that is input at the facility 40, when the new patient is admitted to the facility. For example, the user could be a physician that has been assigned to the patient. If input user name matches, or is similar to the name of the user of a particular remote device 12, an alert is generated on that remote device 12 notifying the user the he/she may have been assigned a new patient. Other constraints could be applied in such cases. By way of one non-limiting example, the alert may only be generated at the remote device 12, if the new patient is a VBAC patient. In another example, the patient's name could be compared to a list of “VIP” patients that has been pre-defined by a particular user. In such cases, the new patient alert will be generated, and the user will be notified if the new patient is on that user's list of “VIP” patients. In this manner, the user will still be notified that the particular patient has been admitted, even though that particular user may not have been assigned as the primary caretaker for that particular patient. For example, even if an attending nurse at the facility 40 entered another user as the primary physician, the user would still be notified that there is a potential VIP patient that has been admitted to a particular facility. In this manner, the user, as a non-primary physician, could still track that particular patient's progress. Such functionality could enable the administrator of the DMS 60, 60′ to coordinate electronic medical records to programmatically feed a particular physician's or physician group's patient names and/or identifiers.

A patient status alert can be generated to notify the user of the remote device to a particular patient condition. By way of non-limiting example, an alert can be generated to notify the user to a change in dilatation, or any parameters associated with a vaginal exam, such as in the exemplar context of a maternity patient. Such alerts could be constrained to only alert the user if the particular patient is listed on the user's “VIP” list, and/or if the particular patient is listed in the user's “My Patients” list (e.g., a list of patients to which the particular user has been assigned as the primary physician. Such alerts could be alternatively constrained, or be further constrained by a particular value. For example, if the particular patient's dilation exceeds a threshold (e.g., 8 centimeters).

Other exemplar patient status alerts can include, but are not limited to, a change in the particular patient's membrane condition (e.g., ruptured), a notification that a particular patient has been administered an epidural, and/or a notification that a particular patient had delivered, or was scheduled for C-section, in the exemplar context of a maternity patient. Such alerts could be constrained to only alert the user if the particular patient is listed on the user's “VIP” list, and/or if the particular patient is listed in the user's “My Patients” list.

By way of another non-limiting example, the user may want to be alerted when a particular patient's dilation progresses past a particular threshold (e.g., 7 centimeters). The user may also configure additional constraints such that, if the particular alert is triggered, the user is made aware of it's relative importance. In this example, the user can configure a rule using the remote device 12, which rule will generate an alert notification if particular patient is included on the user's patient list, if the patient's dilation is greater than or equal to the threshold, if the patient has had an epidural, and if the “My Alerts” option is turned on. In the event that each of these conditions is true, the user is presented with an alert at the remote device 12, such as the alert illustrated in FIG. 5K.

Still other exemplar patient status alerts can include, but are not limited to, a periodic status alerts for each patient that is listed in the particular user's “VIP” list, and/or “My Patients” list. Such periodic status alerts can be constrained to a definable time interval (e.g., every minute, every X minutes, where X is greater than one, every hour, every Y hours, where Y is greater than one, every day, every week, every month, and so on). Such a periodic status alert could notify the user to pertinent patient data and/or information without requiring data and/or information to be retrieved, or without requiring the user to drill down. In order to ensure privacy of the patient data, the user would be required to enter a password and/or PIN, before the pertinent patient data and/or information was presented on the display of the remote device 12.

A patient discharge alert could notify the user that a particular patient is to be discharged from the facility 40. Such an alert could further notify the user of action required by the user to complete such a patient discharge. For example, the patient discharge alert could notify the user is required to sign patient discharge papers. A request alert could notify the user of a request from a caretaker that is on-site (e.g., is at the facility 40), such as a nurse or physician. Such requests could include, but are not limited to, a request that the user review specified patient data and/or information for a particular patient, and could include a message from the on-site caretaker. Such alerts could be clickable to link the user directly to the relevant patient data and/or information (e.g., automatically display the relevant portion of a strip). Again, such alerts could be constrained to only alert the user if the particular patient is listed on the user's “VIP” list, and/or if the particular patient is listed in the user's “My Patients” list.

A system alert could notify the user to certain system conditions. For example, the system alert could notify the user that a particular information system 42, and/or a particular DMS 60, 60′ will be unable, or inaccessible, for a specified reason (e.g., routine maintenance). This may be particularly relevant to the user, if the particular user is on call. Such system alerts could also notify the user of other system disruptions, such as with a particular DMS 60, 60′, a particular information system 42, a particular facility 40, and/or a particular facility system 18, 20.

As discussed above, the user is initially authenticated based on a user ID and password. In some implementations, the user may be required to input a user ID and password for each DMS they are seeking to communicate with. In the exemplar system of FIG. 1, for example, the user may be required to enter a user ID and password to establish secure communications with the DMS of the first facility system, and another user ID and password to establish secure communications with the DMS the second facility system.

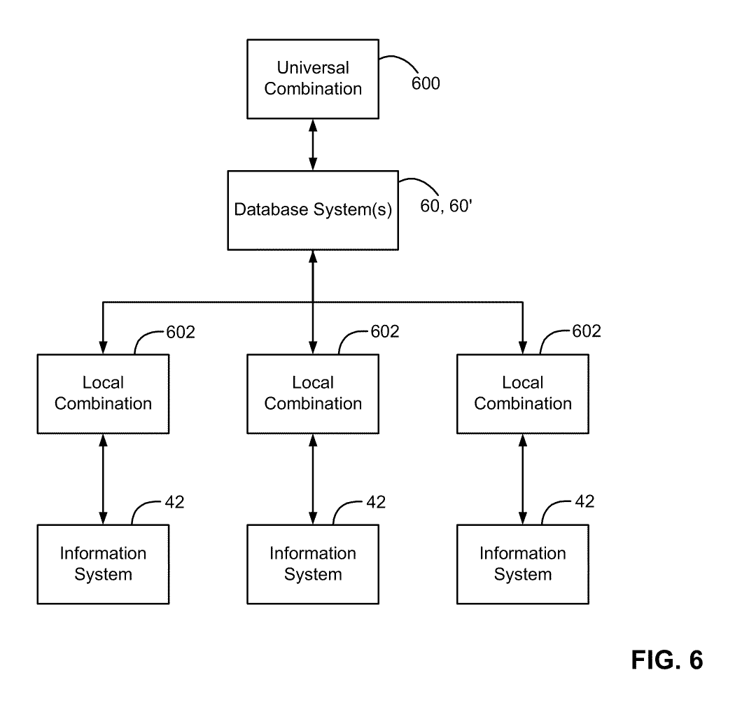

Referring now to FIG. 6, other implementations of the present disclosure provide a single sign-on authentication process. More specifically, a universal user ID and password combination 600 can be provided. Such a universal combination can be created via an initial interaction between the user and the DMS 60, 60′, through which the DMS 60, 60′ authenticates the user, and authenticates which information systems 42 the user is allowed remote access to. In implementations including multiple DMSs 60, 60′, the user can create a single sign-on profile that is universal to the multiple DMSs 60, 60′. During initial generation of the sign-on profile, the user's universal user ID and password combination 600 is associated with one or more local user ID and password combinations 602.

When the user subsequently initiates communication with the information system(s) 42 through the DMS 60, 60′, the user is prompted to input their universal user ID and password combination. The DMS 60, 60′ authenticates the universal user ID and password combination 600 and enables the user to access the DMS 60, 60′. In turn, each information system 42 authenticates the user based on corresponding local user ID and password combinations 602 provided by the DMS 60, 60′. More specifically, the DMS 60, 60′ retrieves multiple local user ID and password combinations 602 based on the universal user ID and password combination 600. In the exemplar illustration of FIG. 6, a first information system 42a authenticates the user based on a first local user ID and password combination 602, a second information system 42b authenticates the user based on a second local user ID and password combination 602, and a third information system 42c authenticates the user based on a second local user ID and password combination 602, each of the local user ID and password combinations 602 being provided by the DMS 60, 60′. Once the user has been authenticated to each of the information systems 42, patient data and/or information can be freely and securely transferred between the remote device 12 and the information system 42 through the DMS 60, 60′.

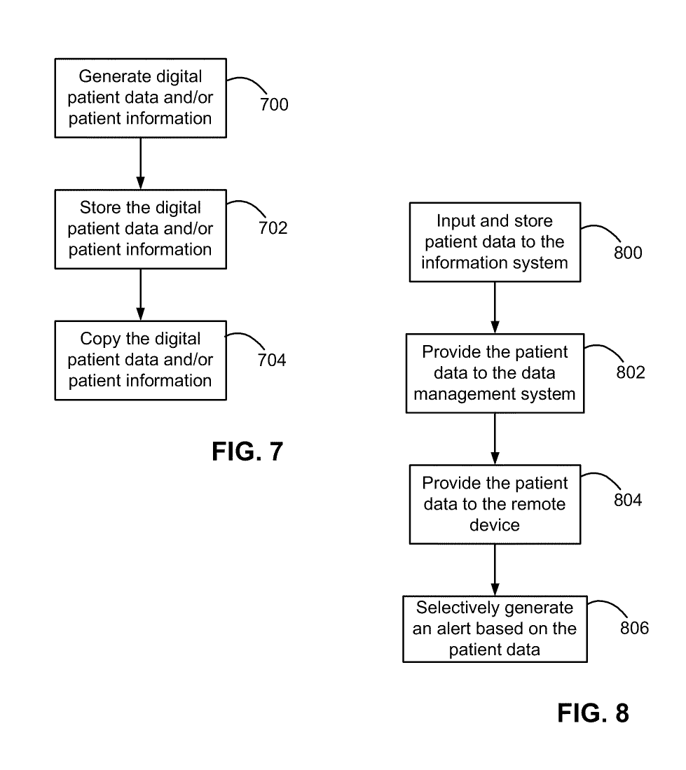

Referring now to FIG. 7, exemplar method steps in accordance with an aspect of the present disclosure will be described in detail. In general, the method steps of FIG. 7 are directed to a method of managing patient data. In step 700, digital patient data and/or patient information is generated at a facility. The facility can include a first facility of a facility system, and the data management system can be located at a second facility of the facility system. In another arrangement, the facility can be a member of a facility system, and the data management system can be resident at a third party location, which is outside of the facility system. In still another arrangement, the facility can be a member of a first facility system, and the data management system can communicate with the first facility system and a second facility system. In step 702, the patient data and/or the patient information is stored in memory of an information system associated with the facility. In step 702, the patient data and/or the patient information is copied to a data management system, the data management system being remotely located from the facility.

In implementations of the method of FIG. 7, communication between the data management system and the information system can be established through a network. In some implementations, the digital patient data can be generated using a patient monitoring device that is in communication with the information system. In some implementations, the patient information can be generated based on user input into the information system. In some implementations, a virtual private network can be established between the data management system and the information system. In some implementations, the data management system can be provided as a virtual server that is logically partitioned within at least one physical server. In some implementations, the data management system is provided as at least part of a server.

Referring now to FIG. 8, exemplar method steps in accordance with an aspect of the present disclosure will be described in detail. In general, the method steps of FIG. 8 are directed to a method of providing remote notifications based on medical data. In step 800 patient data is input to an information system, which information system stores the patient data in a tangible storage device associated therewith. In step 802, the patient data is provided to a data management system that is in communication with the information system, which data management system stores the patient data in a tangible storage device associated therewith. The patient data is provided to a remote device that is in communication with the data management system in step 804. In step 806, an alert is generated on the remote device based on the patient data to alert a user of the remote device of an occurrence.

In implementations of the method of FIG. 8, alert criteria can be provided, and the patient data can be compared to at least a portion of the alert criteria to determine whether to generate a corresponding alert. In some implementations, the alert criteria can include at least one of a threshold and a duration. In some implementations, the alert can be created using at least one of the remote device, and the information system. In some implementations, at least one of a visual indication, an audible indication, and a physical indication can be initiated at the remote device based on the alert. In some implementations, alert criteria can be stored only on the remote device, wherein generation of the alert is further based on the alert criteria. In some implementations, alert criteria can be stored on at least one of the information system, the data management system, and the remote device, wherein generation of the alert is further based on the alert criteria.

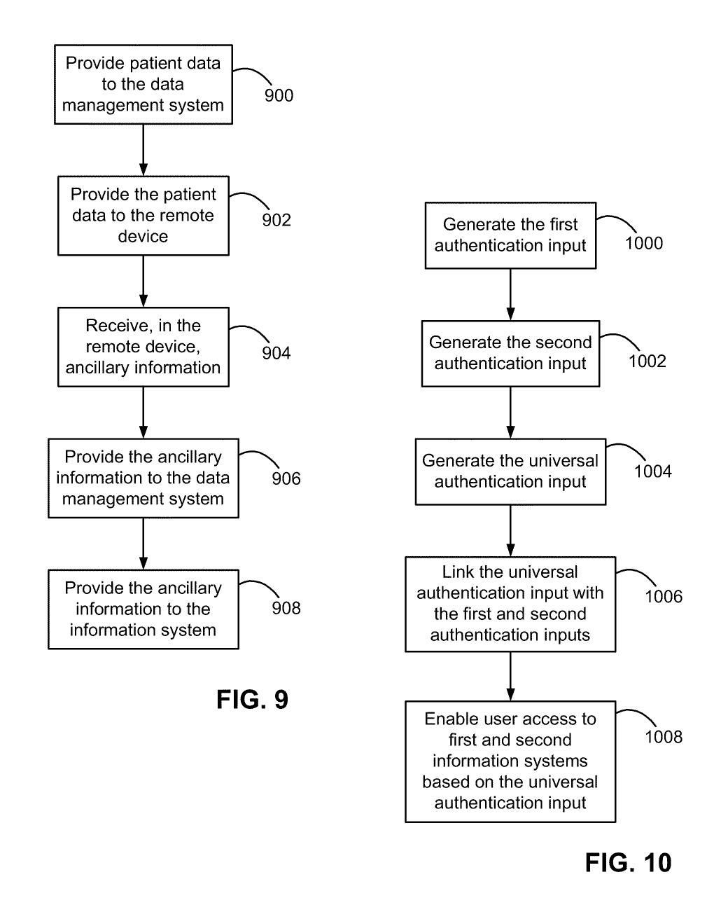

Referring now to FIG. 9, exemplar method steps in accordance with an aspect of the present disclosure will be described in detail. In general, the method steps of FIG. 9 are directed to a method of providing and managing patient data. In step 900 patient data is provided to a data management system that is in communication with an information system located at a facility. In step 902, the patient data is provided to a remote device that is in communication with the data management system. In step 904, ancillary information is received, in the remote device, which ancillary information is input based on the patient data. The ancillary information is provided to the data management system in step 906, and the ancillary information is provided to the information system from the data management system in step 908.

In implementations of the method of FIG. 9, an interface that is associated with the information system can be provided, and the ancillary information can be displayed on the interface. In some implementations, patient data can be displayed on the remote device, and the ancillary information can be associated with particular patient data that is displayed on the remote device. In some implementations, an annotation that is generated at the facility can be displayed on the remote device. In some implementations, the annotation is generated based on user input into the information system. In some implementations, the annotation is automatically generated by a patient monitoring device that is in communication with the information system. In some implementations, a dialog box can be generated on a display of the remote device, and the ancillary information can be input into the remote device using the dialog box. In some implementations, the ancillary information can include at least one of an annotation, a digital image, digital video, audio and an electronic document. In some implementations, the ancillary information can be processed and formatted using the data management system for subsequent display at the facility.

Referring now to FIG. 10, exemplar method steps in accordance with an aspect of the present disclosure will be described in detail. In general, FIG. 10 is directed to a method of providing access to security-critical data. In step 1000, a first authentication input for accessing a first information system is generated. In step 1002, a second authentication input for accessing a second information system is generated. A universal authentication input for accessing a first data management system is generated in step 1004. The universal authentication input can be linked to each of the first and second authentication inputs in step 1006. The first data management system can be in communication with each of the first and second information systems. In step 1008, user access to each of the first and second information systems can automatically be enabled upon authenticating the user to the first data management system based on the universal authentication input.

In implementations of the method of FIG. 10, the universal authentication input can be generated upon an initial interaction between a user and the data management system. In some implementations, each of the first authentication input, the second authentication input, and the universal authentication input can include a respective username and password combination. In some implementations, a third authentication input for accessing a third information system can be generated, wherein the universal authentication input is also linked to the third authentication input, a second data management system can be in communication with the third information system, and user access to each of the first, second and third information systems can be automatically enabled upon authenticating the user to the first and second data management systems based on the universal authentication input.

In some implementation of the method of FIG. 10, a prompt can be generated on a remote device that is in communication with at least one of the first and second data management systems, the universal authentication input can be accepted into the remote device in response to the prompt, and the universal authentication input can be communicated to the at least one of the first and second data management systems for authenticating the user. In some implementations, the first and second authentication inputs can be stored into memory of the first data management system, at least one of the first and second authentication inputs can be retrieved from memory based on the universal authentication input, and the user can be authenticated to at least one of the first and second information systems based on the respective at least one of the first and second authentication inputs. In some implementations, data between a remote device and at least one of the first and second information systems can be transferred upon authentication of the user.

The present disclosure can be implemented in digital electronic circuitry, or in computer hardware, firmware, software, or in combinations thereof. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Such a computer program can include modules and/or code segments for executing one or more of the features, aspects and/or implementations provided herein.

Method steps of the present disclosure can be performed by one or more programmable processors executing a computer program product to perform functions of the present disclosure by operating on input data and generating output. By way of one non-limiting example, a computer program product can include modules and/or code segments corresponding to each of the method steps, aspects and/or features provided herein. Method steps can also be performed by, and apparatus of the present disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The present disclosure can be implemented in a system including, but not limited to the exemplar systems described herein, which include a back-end component, e.g., as a data server, or that includes a middleware component, e.g., an application server, or that includes a front-end component, e.g., a client device, such as the remote device 12, having a graphical user interface or a Web browser through which a user can interact with an implementation of the invention, or any combination of such back-end, middleware, or front-end components. The components of the system can be interconnected by any form or medium of digital data communication, e.g., a communication network.

A number of embodiments have been described. Nevertheless, it will be understood that various modifications may be made without departing from the spirit and scope of the disclosure. For example, steps of the invention can be performed in a different order and still achieve desirable results. Accordingly, other embodiments are within the scope of the following claims.

What is claimed is:

1. A method of providing and managing patient data, the method comprising:
providing patient data to a data management system that is in communication with an information system located at a facility;
providing the patient data to a remote device that is in communication with the data management system;
receiving, in the remote device, ancillary information that is input based on the patient data;
providing the ancillary information to the data management system; and
providing the ancillary information to the information system from the data management system.

2. The method of claim 1, further comprising:
providing an interface that is associated with the information system; and
displaying the ancillary information on the interface.

3. The method of claim 1, further comprising:
displaying patient data on the remote device; and
associating the ancillary information with particular patient data that is displayed on the remote device.

4. The method of claim 1, further comprising displaying an annotation on the remote device, which annotation having been generated at the facility

5. The method of claim 4, wherein the annotation is generated based on user input into the information system.

6. The method of claim 4, wherein the annotation is automatically generated by a patient monitoring device that is in communication with the information system.

7. The method of claim 1, further comprising:
generating a dialog box on a display of the remote device; and
inputting the ancillary information into the remote device using the dialog box.

8. The method of claim 1, wherein the ancillary information includes at least one of an annotation, a digital image, digital video, audio and an electronic document.

9. The method of claim 1, further comprising processing and formatting the ancillary information using the data management system for subsequent display at the facility.

10. A machine-readable storage device encoded with a computer program comprising instructions that, when executed, operate to cause one or more processors to perform operations comprising:
providing patient data to a data management system that is in communication with an information system located at a facility;
providing the patient data to a remote device that is in communication with the data management system;
receiving, in the remote device, ancillary information that is input based on the patient data;
providing the ancillary information to the data management system; and
providing the ancillary information to the information system from the data management system.

11. The machine-readable storage device of claim 10, wherein the operations further comprise:
providing an interface that is associated with the information system; and
displaying the ancillary information on the interface.

12. The machine-readable storage device of claim 10, wherein the operations further comprise:
displaying patient data on the remote device; and
associating the ancillary information with particular patient data that is displayed on the remote device.

13. The machine-readable storage device of claim 10, wherein the operations further comprise displaying an annotation on the remote device, which annotation having been generated at the facility

14. The machine-readable storage device of claim 13, wherein the annotation is generated based on user input into the information system.

15. The machine-readable storage device of claim 13, wherein the annotation is automatically generated by a patient monitoring device that is in communication with the information system.

16. The machine-readable storage device of claim 10, wherein the operations further comprise:
generating a dialog box on a display of the remote device; and
inputting the ancillary information into the remote device using the dialog box.

17. The machine-readable storage device of claim 10, wherein the ancillary information includes at least one of an annotation, a digital image, digital video, audio and an electronic document.

18. The machine-readable storage device of claim 10, wherein the operations further comprise processing and formatting the ancillary information using the data management system for subsequent display at the facility.

19. A system, comprising:
one or more processors; and
a machine-readable storage device coupled to the one or more processors having instructions stored thereon which, when executed by the one or more processors, causes the one or more processors to perform operations comprising:
providing patient data to a data management system that is in communication with an information system located at a facility;
providing the patient data to a remote device that is in communication with the data management system;
receiving, in the remote device, ancillary information that is input based on the patient data;
providing the ancillary information to the data management system; and
providing the ancillary information to the information system from the data management system.

20. The system of claim 19, wherein the operations further comprise:
providing an interface that is associated with the information system; and
displaying the ancillary information on the interface.

21. The system of claim 19, wherein the operations further comprise:
displaying patient data on the remote device; and
associating the ancillary information with particular patient data that is displayed on the remote device.

22. The system of claim 19, wherein the operations further comprise displaying an annotation on the remote device, which annotation having been generated at the facility

23. The system of claim 22, wherein the annotation is generated based on user input into the information system.

24. The system of claim 22, wherein the annotation is automatically generated by a patient monitoring device that is in communication with the information system.

25. The system of claim 19, wherein the operations further comprise:
generating a dialog box on a display of the remote device; and
inputting the ancillary information into the remote device using the dialog box.

26. The system of claim 19, wherein the ancillary information includes at least one of an annotation, a digital image, digital video, audio and an electronic document.

27. The system of claim 19, wherein the operations further comprise processing and formatting the ancillary information using the data management system for subsequent display at the facility.
